(19) United States
(12) Patent Application Publication
(10) Pub. No.: US 2015/0178319 A1
(43) Pub. Date: Jun. 25, 2015

(54) Suggesting Interesting Dates to Explore Images in a Historical Imagery Database

(71) Applicants: Chris CO, San Jose, CA (US); Jayant Kolhe, Saratoga, CA (US)

(72) Inventors: Chris CO, San Jose, CA (US); Jayant Kolhe, Saratoga, CA (US)

(73) Assignee: Google Inc., Mountain View, CA (US)

(21) Appl. No.: 13/305,352

(22) Filed: Nov. 28, 2011

(51) Int. Cl. G06F 17/30

(52) U.S. Cl. CPC G06F 17/30268; G06F 17/30241

(57) ABSTRACT

A computer-implemented method, system and computer-readable medium for suggesting a date to display a historical image, is provided. A plurality of tiles corresponding to a geographic area are identified. Some or all of the geographic area can be displayed to a user. For each tile, a list of dates is identified, each date in the list associated with a historical image geolocated at a geolocation of each tile on a particular date. From the list of dates associated with each tile, an oldest date is identified. The oldest date from each list of dates associated with each tile is compiled into a suggested date list. From the suggested date list, a date is selected as the suggested date, that accounts for the age of available historical images and the availability of historical images having the suggested date within the image displayed to the user.

### BACKGROUND

Historical imagery of a location allows users to view the images in the world from previous years. For example, a user may use a computing device to select a geographic location and be presented with images of the selected geographic location at different points in time. By selecting different years, a user may view how the selected location has changed throughout the years. For example, when a user selects a metropolitan area, such as Washington, D.C. or New York City, a user may view historical images of those cities throughout the years, identify new buildings that were built, and old buildings that have been demolished.

As the user views the historical images of a location, the imagery of some years may be more interesting than of other years. For example, a time period that promoted rapid growth in a city, or a time period during which a historic landmark was built may be more interesting to a user. However, a user may not easily identify which years include interesting historical imagery.

### BRIEF SUMMARY

A computer-implemented method, system and computer-readable medium for suggesting a date to display a historical image, is provided. A plurality of tiles corresponding to a geographic area are identified. Some or all of the geographic area can be displayed to a user. For each tile, a list of dates is identified, each date in the list associated with a historical image geolocated at a geolocation of each tile on a particular date. From the list of dates associated with each tile, an oldest date is identified. The oldest date from each list of dates associated with each tile is compiled into a suggested date list. From the suggested date list, a date is selected as the suggested date, that accounts for the age of available historical images and the availability of historical images having the suggested date within the image displayed to the user.

Further embodiments, features, and advantages of the invention, as well as the structure and operation of the various embodiments of the invention are described in detail below with reference to the accompanying drawings.

### BRIEF DESCRIPTION OF THE DRAWINGS/FIGURES

The accompanying drawings, which are incorporated herein and form a part of the specification, illustrate embodiments of the invention and, together with the description, further serve to explain the principles of the invention and to enable a person skilled in the relevant art to make and use the invention.

FIG. 1 is a block diagram of an image processing and display environment, where the embodiments of the invention can be implemented.

FIG. 2 is a block diagram of a tile associated with historical images, according to an embodiment.

FIG. 3 is a block diagram of tiles from which a suggested date that corresponds to an interesting image of a location is determined, according to an embodiment.

FIG. 4 is a screenshot of tiles that display a historical image of a location having a suggested date, according to an embodiment.

FIG. 5 is a flow chart of a method for suggesting a date that corresponds to a historical image, according to an embodiment.

FIG. 6 is a block diagram of a computer system in which embodiments of the invention can be implemented.

The invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF EMBODIMENTS

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

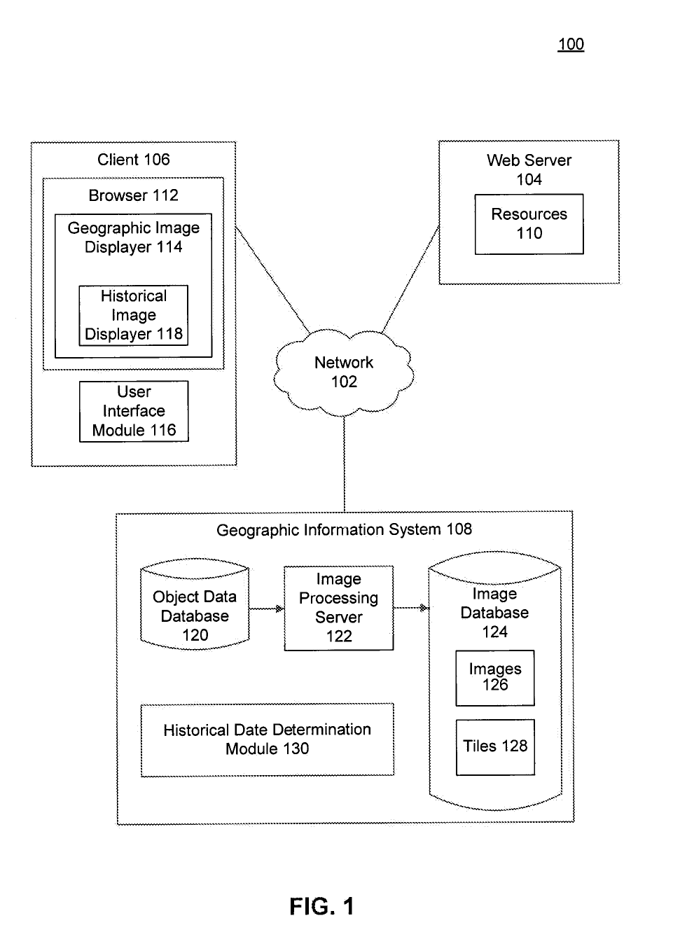

FIG. 1 is a block diagram of an exemplary image processing and display environment 100. The image processing and display environment 100 includes one or more networks 102, web servers 104, client devices 106, and geometric information systems (GISs) 108.

Network 102 may be any network or combination of networks that can carry data communication. Such a network 102 may include, but is not limited to, a local area network, metropolitan area network, and/or wide area network such as the Internet. Network 102 can support technologies including, but not limited to the World Wide Web (“the Web”) that provide access to services and applications using protocols, such as a HyperText Transfer Protocol (“HTTP”). Intermediate web servers, gateways, or other servers may be provided between components of the system shown in FIG. 1, depending upon a particular application or environment.

Web server 104 is a computing device that hosts multiple resources 110. Web server 104 transmits resources 110 to client devices 106. Web server 104 may also retrieve resources 110 from other computing devices and provide resources 110 to client devices 106.

A resource 110 is any data that can be provided over network 102. Resource 110 is identified by a resource address that is associated with resource 110. Resources 110 include web pages such as HyperText Markup Language (HTML) pages, scripts, word processing documents, portable document format (PDF) documents, images, and video, to name only a few. Resources 110 can also include content, such as words, phrases, images and sounds, that may include embedded information (such as meta-information in hyperlinks) and/or embedded instructions (such as JavaScript scripts).

Client device 106 is an electronic device that is manipulated by a user and is capable of requesting and receiving resources 110 over network 102. Example client devices 106 are personal computers, laptop computers, smart phones, and tablet computers, to name only a few. Client devices 106 typically include an application, such as a web browser (or simply “browser”) 112. A user uses browser 112 to request resources 110 over network 102. For example, a user requests resource 110 by typing, selecting or entering an identifier (such as a URL) of a resource stored on web server 104. In response to a request, web server 104 transmits resource 110 to client device 106.

Example resource 110 may also include an application, such as a geographic image displayer 114. Geographic image displayer 114 displays images of Earth. Geographic image displayer 114 may display aerial imagery of the entire Earth or a continent on Earth, in one embodiment. In another embodiment, geographic image displayer 114 may receive and display images of a particular country, state, city, city block, etc. Geographic image displayer 114 allows a user to select a particular location in the world, and then retrieve and display images associated with that location. In addition, the functionality of geographic image displayer 114 may be extended to display images of other locations, such as solar systems, stars, moons, galaxies, oceans, shipwrecks, etc.

When geographic image displayer 114 displays images of Earth, geographic image displayer 114 displays Earth as a three-dimensional sphere that is mapped to a two-dimensional display. Geographic image displayer 114 displays Earth from a distance above the Earth. For example, in one embodiment, a location may be viewed from a perspective of a virtual camera that is located a distance “d” above the Earth. As distance “d” increases between the virtual camera and the actual location on Earth, a larger area of the three-dimensional sphere becomes visible. As the distance “d” between the virtual camera and the image decrease, the details of a particular location, such as a county, city, street, etc., become more granular and visible on client device 106.

In one embodiment, a three-dimensional representation of Earth or a location on Earth may be represented on a two-dimensional display, such as a display screen on client device 106. To represent a location in a two-dimensional space, multiple, non-overlapping tiles are mapped onto the three-dimension sphere. Each tile represents a location in the three dimensional sphere, having a range of coordinates, such as a range of latitude coordinates and a range of longitude coordinates. The image of a particular location on Earth may be overlaid over each tile, and displayed on client device 106. Given a constant level of detail, the greater the distance “d” between the Earth and the virtual camera the greater number of tiles are visible on the display screen of client device 106, and the lesser the distance “d” between the Earth and the virtual camera, the fewer tiles are visible on client device 106. As the number of tiles becomes more numerous, a coarser level of detail may be displayed. At a coarser level of detail, each tile may represent a larger geographic area at a lower resolution.

Tiles may be any geometric shape that can be connected together in a non-overlapping way. Example tiles may include rectangular or square tiles.

To select a particular location, client device 106 includes a user interface module 116. User interface module 116 receives a user selection of a desired location. User interface module 116 may receive a location when a user selects a particular location on Earth. For example, user interface module 116 may receive a selection when a user points a mouse to a desired location in the sphere that represents Earth, and clicks or otherwise selects the location. The selection may be fine-tuned when user interface module 116 receives instructions to “zoom in” or increase the granularity of a particular location, prior to the selection. User interface module 116 may also receive instructions from a user using a touch-screen display, a keyboard, a voice recognition application, etc.

Once user interface module 116 receives a selection, geographic image displayer 116 converts the selection into a geographic coordinate format, such as a latitude/longitude format, or a three-dimension space “x”, “y”, “z” coordinate format, to name a few examples. Once geographic image displayer 114 identifies the selected coordinates, geographic image displayer 114 transmits a request message to GIS 108. The request message includes a request for tiles that are mapped to coordinates identified by geographic image displayer 114. In response, GIS 108 selects one or more tiles that correspond to the coordinates included in the request message. GIS 108 also selects images that are associated with the selected tiles. GIS 108 then generates a response message that includes selected tiles and images, and transmits the response message to geographic image displayer 114. The methods for selecting tiles for display in geographic image displayer 114 are known to a person of ordinary skill in the art, and are outside of the scope of this patent application.

Geographic image displayer 114 may also include a historical image displayer 118. Historical image displayer 118 displays historical images of locations that were selected for viewing by a user. For example, historical image displayer 118 allows a user to view images of a location on Earth at various instances in the past. In one embodiment, when geographic image displayer 114 presents a user with an aerial view of a location, a user may activate historical image displayer 118. When activated, historical image displayer 118 presents a user with a timeline that includes a selection of several dates in the past. When a user selects a particular date, a user is presented with an image of a location that corresponds to a selected date. As described in detail below, historical image displayer 118 may also select an interesting date for a user and include an image that corresponds to the selected date.

In an embodiment, historical image displayer 118 may be activated using user interface module 116.

Geographic information systems (GIS) 108 is a system for archiving, retrieving, displaying, or manipulating data elements indexed according to the data element's geographic coordinates. A data element may be a variety of data types such as, for example, satellite imagery, maps, models of buildings and terrain, and other geographic features. Geographic image displayer 114 and historical image displayer 118 communicate with GIS 108 directly or through web server 104 to retrieve data (such as tiles and images) that is requested by client device 106. In one example, GIS 108 uploads images of Earth and other geospatial data to client device 106 for viewing by a user. Together, the images of the Earth and other geospatial data form a three-dimensional model that is presented on a two-dimensional display screen of client device 106.

GIS 108 includes an object database 120, an image processing module 122 and an image database 124. Object database 120 may be an image database of unprocessed images (or raw images) associated with geographic data. The images may be photographic images that include, but are not limited to, portions of panoramic images, such as street-level panoramas or satellite images. In an embodiment, object database 120 may be a third-party database. Images in object database 120 may be associated with particular dates. For example, each image may include credentials that identify the date and time the images was taken or stored in object database 120.

Image processing server 122 retrieves and processes images from object database 120. Image processing server 122 processes the unprocessed images into images 126 that may be presented using a GIS application, such as geographic image displayer 114 on client device 106. The processed images are then stored in image database 124.

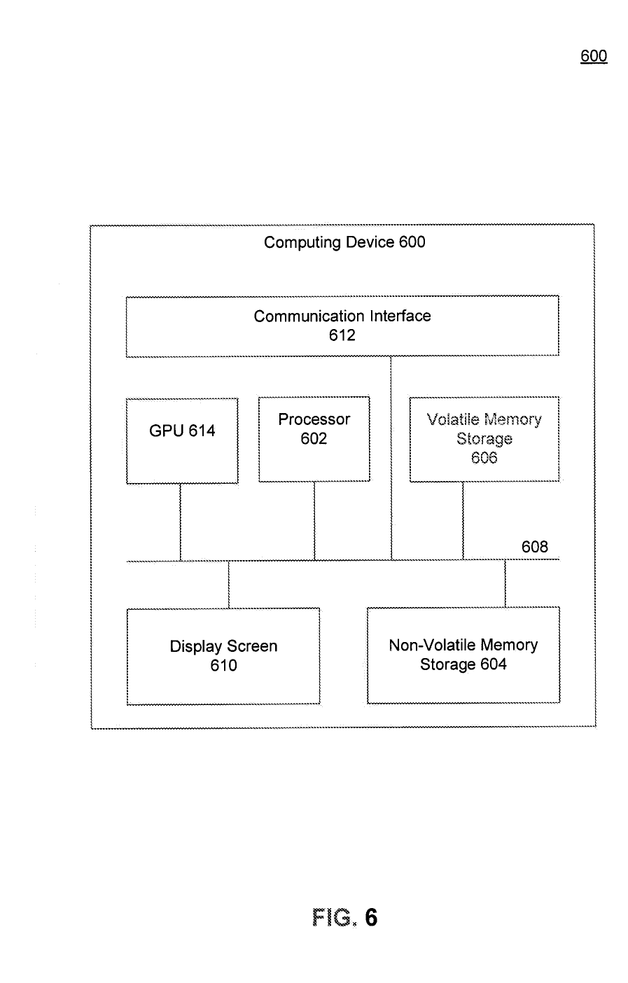

Image database 124 may be a memory storage (described in detail in FIG. 6) that, for example, includes a database. Image database 124 stores images 126 that are processed by image processing server 122. Those images 126 may be displayed on client device 106 using tiles 128 and geographic image displayer 114.

Image database 124 also stores multiple tiles 128. Each tile 128 is associated with geospatial data, such as geographic coordinates of the Earth and one or more images that are associated with those coordinates. Together, multiple tiles 128 generate image 126 that is displayed on client device 106. When client device 106 requests an image of a location selected using user interface module 116, GIS 108 returns a response message that includes one or more tiles 128. Each tile 128 is associated with an image from image database 124.

Images 126 may also be historical images. Historical images are images 126 of a location on Earth at some point in the past. For example, historical images may display imagery of Washington DC or New York City in early 1900s or 1950s. Typically, a historical image is associated with a date the image was taken on or included into object data database 120.

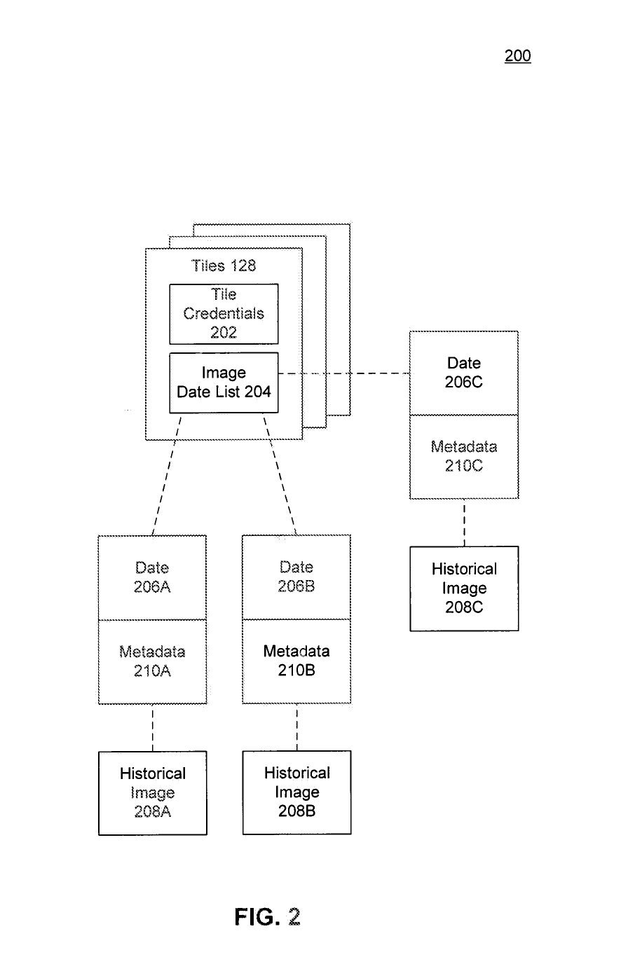

FIG. 2 is a block diagram of a tile associated with a historical image, according to an embodiment. Tile 128 includes tile credentials 202 and image date list 204. Tile credentials 202 include credentials that are associated with each tile 128. Example tile credentials 202 may include a tile identifier, the position of the tile in the two-dimensional representation of Earth, and the geographic coordinates that correspond to the location, etc.

Image date list 204 is a listing that includes dates 206 and image metadata 210 that is associated with the geographic coordinates that correspond to tile 128. Each date 206 in image date list 204 is associated with a historical image 208. Historical image 208 is an image of a location displayed by tile 128 at a particular instance in the past. For example, date 206A is associated with image 208A, where image 208A depicts a location displayed in tile 128 on date 206A. Similarly, date 206B is associated with image 208B that depicts the same location on date 206B, and date 206C is associated with image 208C that depicts the location on date 206C.

Metadata 210 includes information and instructions for retrieving corresponding image 208 from image database 126. For example, metadata 210A includes information for retrieving image 208A, metadata 210B includes information for retrieving image 208B, and metadata 210C includes information for retrieving image 208C. Example metadata 210 may include the location of image 208 in image database 126, image identifier, etc.

In a further embodiment, dates 206 in image date list 204 may be in chronological order, beginning with the oldest date 206.

Additionally, each date 206 may have a different level of granularity. In one embodiment date 206 may include a year that the image was taken. In another embodiment, date 206 may include more granular information that is specific to a month, a week or a day when the image was taken.

Going back to FIG. 1, GIS 108 also includes a historical date determination module 130. Historical date determination module 130 identifies a historical date that is associated with image 126 of a location that may be interesting to the user. In one embodiment, an image that is interesting to the user may be the oldest image of the location. For example, an image of Washington DC or New York City that is from 1900 may be interesting to a user. Typically, older images are more interesting, but older images are not as available as newer images. Because a view often includes many different images, simply selecting the oldest image for each area would lead to a patchwork view that may be disorienting for a user.

To suggest a historical date of image 126 that may be interesting to a user, historical date determination module 130 analyzes tiles 128 that are included in image 126 displayed on client device 106. As described herein, GIS 108 selects tiles 128 that comprise an image for a particular location based on the coordinates submitted by client device 106. The coordinates may be, for example, coordinates visible to a user. In another embodiment, the client may send a virtual camera specification, identifying a position and orientation of a user's view in a three-dimensional environment, to the GIS 108, and GIS 108 may determine the coordinates visible to a user. Each tile 128 may be completely or partially displayed on client device 106. When a user activates historical image displayer 118, historical date determination module 130 receives a listing of tiles 128 that comprise image 126, tile credentials 202 and image date list 204 associated that each tile 128.

In an embodiment, historical date determination module 130 may also be located on client device 106 (embodiment, not shown). In this embodiment, when client device 106 receives tiles 128 on client device 106, tile credentials 202 and image date list 204 are included with tiles 128.

To determine an interesting date for image 126, historical date determination module 130 generates a suggested date list. The suggested date list includes an oldest date from dates 206 included in image date list 204 associated with each tile 128. It is important to note, that dates 206 in image date list 204 associated with each tile 128 may be in chronological order, beginning with the oldest date. Thus, by selecting the oldest date in the listing (which is the first date), historical date determination module 130 may improve efficiency of the suggested date determination process.

Once historical date determination module 130 identifies a suggested date list, historical date determination module 130 identifies a suggested date within the suggested date list. In one embodiment, the suggested date in the suggested date list may be the most recent date. For example, when image database 126 stores images of locations, images that correspond to more recent dates tend to include more content than the older images. In one embodiment, the suggested date is selected to account for the age of available historical images stored in image database 124 and the availability of historical images having the suggested date within the image 126 displayed to the user.

Thus, to determine an interesting date for a historical image, in one embodiment, historical date determination module 130 may select the most recent date in the suggested date list. Once historical date determination module 130 selects the interesting date, GIS system 108 provides the selected date to client device 106. In an embodiment, GIS system 108 may also provide images 208 that are associated with the suggested date for tiles 128 that comprise image 126.

In another embodiment, the suggested date list may include duplicates. For example, when historical determination module 130 identifies more than one tile 128 that has the same oldest date as other tiles, historical date determination module 130 includes both instances of the same date in the suggested date list. Once the suggested date list is identified, historical date determination module 130 may then select the suggested date as the date that repeats the most in the suggested date list. In another embodiment, historical date determination module 130 may select an interesting date as the most recent date that appears a number of times in the suggested date list that is greater than the predefined threshold. In this way, historical determination module 130 identifies the oldest date for which imagery is available in most or all of a user's view.

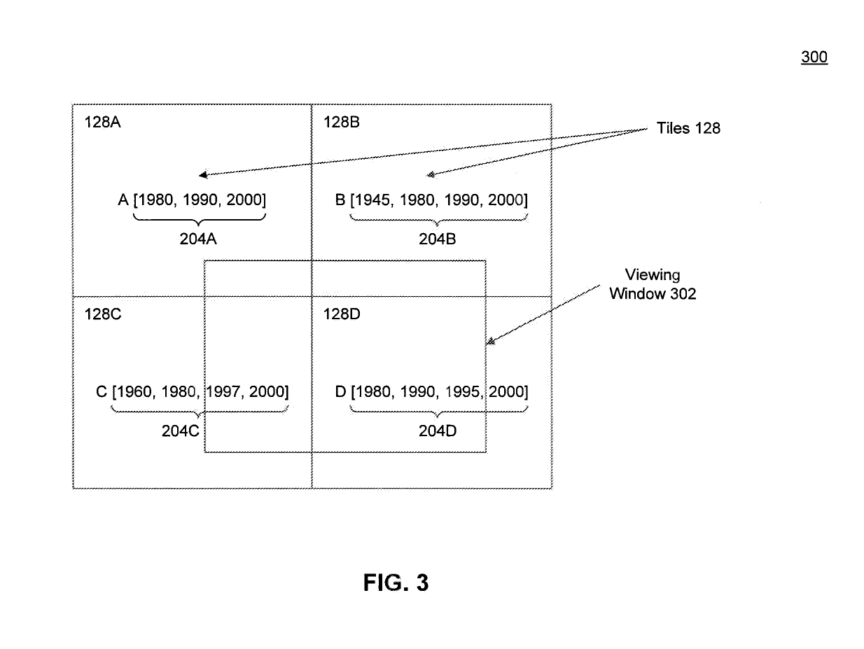

FIG. 3 is a block diagram 300 of tiles trom which a date that corresponds to an interesting image of a location is determined, according to an embodiment. In block diagram 300, client device 106 selects an image that comprises tiles 128A-D. Some or all portions of tiles 128A-D are displayed on a display screen of client device 106. In an embodiment, display screen may include a viewing window 302. Viewing window 302 displays the portions of image included in tiles 128A-D on a display screen of client device 106. As shown in block diagram 300, viewing window 302 may include some or all portions of each tile 128A-D.

Each tile 128A-D is associated with image date list 204A-D. For example, in FIG. 3, image date list 204A associated with tile 128A, includes dates: 1980, 1990 and 2000.

Image date list 204B associated with tile 128B, includes dates: 1945, 1989, 1990 and 2000.

Image date list 204C associated with tile 128C, includes dates: 1960, 1980, 1997, and 2000.

Image date list 204D associated with tie 128D includes dates: 1980, 1990, 1995 and 2000.

Each date 206 in image date lists 204A-D is associated with historical image 208 that corresponds to date 206 in corresponding tiles 128 A-D. It is important to note, that dates 206 in image date lists 204A-D may sorted (e.g. chronologically) to maximize efficiency and reduce computer processing time for identifying an interesting date.

To determine an interesting date, historical date determination module 130 generates a suggested date list, as described above. To generate the suggested date list, historical date determination module 130 selects an oldest date from dates in each date list 204A-D. The exemplary suggested date list from image date list 204A-D includes dates: 1945, 1960, and 1980.

From the suggested date list, historical date determination module 130 determines a suggested date. For example, historical date determination module 130 identifies the most recent date from the suggested date list, which, in the example above, is 1980. Once historical date determination module 130 identifies the suggested date, GIS 108 transmits the suggested date to client device 106.

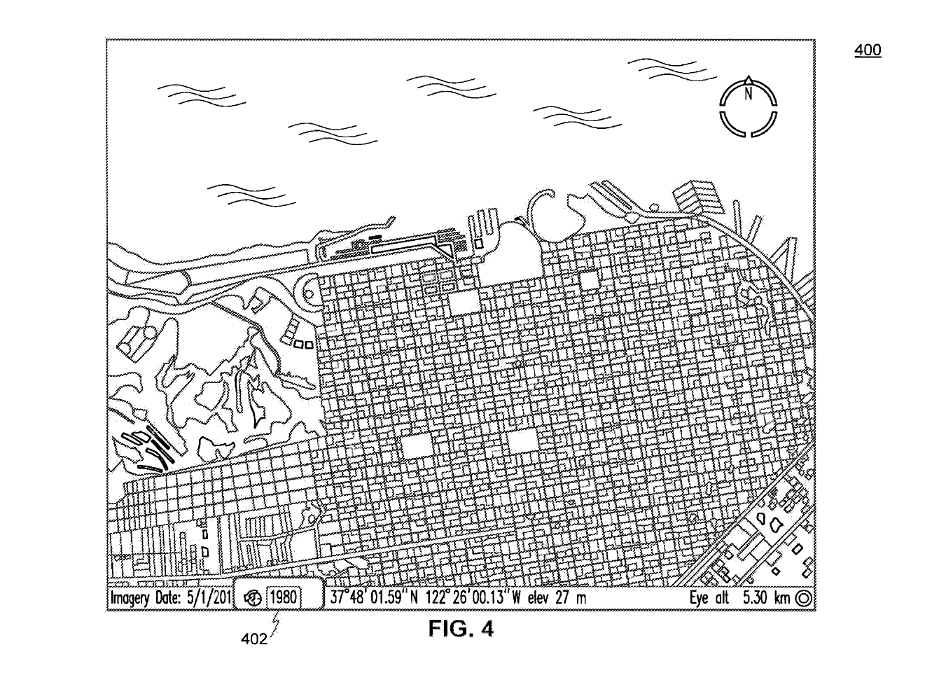

FIG. 4 is a screenshot 400 of tiles that display a historical image of a location having a suggested date, according to an embodiment. Once historical date determination module 130 identifies a suggested date, GIS 108 transmits the suggested date to client device 106. Once client device receives the suggested date, historical image displayer 118 displays the suggested date in the viewing window 302 of the display screen. In one embodiment, suggested historical date may be included as date 402. When a user clicks on date 402, a user may be presented with a historical image of the location on that particular date. In another embodiment, GIS 108 transmits images 208 in tiles 128 that correspond to the suggested date. In this embodiment, client device 106 may display the suggested date and image 126 that comprises images 208 that corresponds to the suggested date.

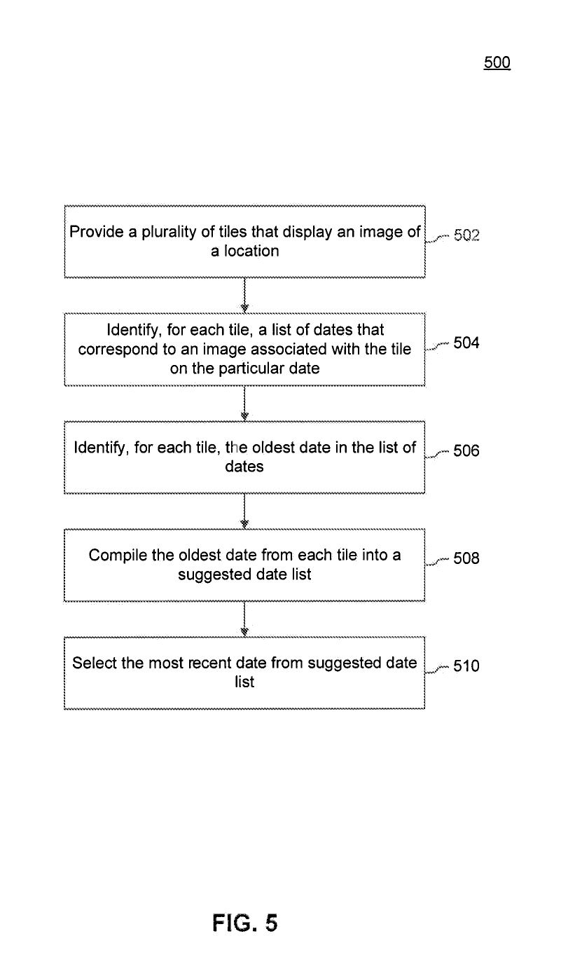

FIG. 5 is a flow chart of a method for suggesting a date that corresponds to a historical image (stages 502-510), according to an embodiment.

At stage 502, a list of tiles is provided. A list of tiles that correspond to the tiles displaying image 126 on client device 106 is provided to historical date determination module 130. As described herein, historical date determination module 130 analyzes image date list 204 of each tile 128 to suggest an interesting historical date for image 126 displayed on client device 106.

At stage 504, a list of dates associated with each tile is identified. For example, historical date determination module 130 identifies image date list 204 that includes dates 206 that are associated with historical images 208. In an embodiment, image date list 204 for each tile 128 may be in chronological order.

At stage 506, for each tile, an oldest date in the list is identified. For example, for each tile 128, historical date determination module 130 identifies an oldest date in the list of dates.

At stage 508, a suggested date list is compiled. For example, historical date determination module 130 compiles dates for each tile 128 identified in stage 506 into a suggested date list.

At stage 510, a date in the suggested date list is selected. For example, historical date determination module 130 selects a most recent date from the suggested date list as the date that corresponds to an image that may be interesting to the user. Once historical date determination module 130 selects the suggested date, GIS 108 transmits the suggested date for display to client device 106.

FIG. 6 is an example computer system 600 in which embodiments of the present invention, or portions thereof, may be implemented as computer-readable code. For example, the components or modules of image processing and display environment 100, browser 110, geographic image displayer 114, historical image displayer 118, user interface module 116, image processing server 122 and historical date determination module 130, etc., may be implemented in one or more computer systems 600 using hardware, software, firmware, tangible computer-readable media having instructions stored thereon, or a combination thereof and may be implemented in one or more computer systems or other processing systems. Modules and components in FIGS. 1-5 may be embodied in hardware, software, or any combination thereof.

Client device 106, origin server 104, and other devices in image processing and display environment 100 may include one or more computing devices. Those computing devices may include one or more processors 602, one or more non-volatile storage mediums 604, one or more memory devices 606, a communication infrastructure 608, a display screen 610 and a communication interface 612.

Processors 602 may include any conventional or special purpose processor, including, but not limited to, digital signal processor (DSP), field programmable gate array (FPGA), and application specific integrated circuit (ASIC).

GPU 614 is a specialized processor that executes instructions and programs, selected for complex graphics and mathematical operations, in parallel.

Non-volatile storage 604 may include one or more of a hard disk drive, flash memory, and like devices that may store computer program instructions and data on computer-readable media. One or more of non-volatile storage device 604 may be a removable storage device.

Memory devices 606 may include one or more volatile memory devices such as but not limited to, random access memory. Communication infrastructure 608 may include one or more device interconnection buses such as Ethernet, Peripheral Component Interconnect (PCI), and the like.

Typically, computer instructions are executed using one or more processors 602 and one or more GPUs 614. Computer instructions can be stored in non-volatile storage medium 604 or memory devices 606. Computer instructions may be stored on a computing device in a compiled file, an executable file or a dynamically linked libraries or objects. Computer instructions may also be compiled on a computing device prior to execution or interpreted on the computing device. In a non-limiting example, computer instructions may be included in a routine, a subroutine, or layers of a software stack that are manipulated by processors 602 or GPUs 614.

Display screen 610 allows results of the computer operations to be displayed to a user or an application developer.

Communication interface 612 allows software and data to be transferred between computer system 600 and external devices. Communication interface 612 may include a modem, a network interface (such as an Ethernet card), a communications port, a PCMCIA slot and card, or the like. Software and data transferred via communication interface 612 may be in the form of signals, which may be electronic, electromagnetic, optical, or other signals capable of being received by communication interface 612. These signals may be provided to communication interface 612 via a communications path. The communications path carries signals and may be implemented using wire or cable, fiber optics, a phone line, a cellular phone link, an RF link or other communications channels.

Embodiments also may be directed to computer program products comprising software stored on any computer-useable medium. Such software, when executed in one or more data processing device, causes a data processing device(s) to operate as described herein. Embodiments of the invention employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

1. A system for suggesting a date to display an image, comprising:
a memory;
a processor coupled to the memory;
a historical date suggestion module stored in the memory and executing on the processor and configured to:
receive a request to display a geographic area having particular geographic coordinates to a user;
identify a plurality of tiles, the plurality of tiles corresponding to the geographic area having the particular geographic coordinates in response to the received request;
for each tile:
identify a list of dates, each date being associated with a historical image geolocated at a geolocation of each tile on a particular date; and
identify an oldest date in the list of dates;
compile the oldest date from each tile into a suggested date list; and
select a most recent date or most repeated date from the suggested date list as a suggested date for displaying the historical image, whereby the suggested date is selected to account for the age of available historical images and the availability of historical images having the suggested date within the image displayed to the user.

2. (canceled)

3. (canceled)

4. The system of claim 1, wherein the historical date suggestion module is further configured to select the suggested date as the most recent date in the suggested date list that repeats a number of times above a predefined threshold.

5. The system of claim 1, further comprising a communication interface configured to provide the suggested date to a computing device.

6. The system of claim 1, further comprising a geographic information system (GIS) configured to:
receive a request for the plurality of tiles having the suggested date;
identify the historical image for each tile in the plurality of tiles that corresponds to the suggested date; and
transmit the identified historical images for display on a computing device.

7. The system of claim 1, wherein the list of dates is in a chronological order beginning with the oldest date in the list.

8. The system of claim 1, further comprising:
a user interface module configured to receive a request to display the geographic area having the particular geographic coordinates; and
a geographic image displayer configured to:
receive the request from the user interface module and query the plurality of tiles in response to the request.

9. The system of claim 1, wherein each tile is mapped onto a three-dimensional representation of a sphere that represents Earth.

10. A computer-implemented method for suggesting a date to display an image, comprising:
receiving a request to display a geographic area having particular geographic coordinates to a user;
identifying a plurality of tiles, the plurality of tiles corresponding to the geographic area having the particular geographic coordinates in response to the received request;
for each tile:
identifying a list of dates, each date being associated with a historical image geolocated at a geolocation of each tile on a particular date; and
identifying an oldest date in the list of dates;
compiling the oldest date from each tile into a suggested date list; and
selecting a most recent date or most repeated date from the suggested date list as a suggested date for displaying the historical image, whereby the suggested date is selected to account for the age of available historical images and the availability of historical images having the suggested date within the image displayed to the user.

11. (canceled)

12. (canceled)

13. The computer-implemented method of claim 10, further comprising:
selecting the suggested date as the most recent date in the suggested date list that repeats a number of times above a predefined threshold.

14. The computer-implemented method of claim 10, further comprising:
providing the suggested date to a computing device.

15. The computer-implemented method of claim 10, further comprising:
receiving a request for the plurality of tiles having the suggested date;
identifying the historical image for each tile in the plurality of tiles that corresponds to the suggested date; and
transmitting the identified historical images for display on a computing device.

16. The computer-implemented method of claim 10, wherein the list of dates is in a chronological order beginning with the oldest data in the list.
sorting the list of dates that corresponds to each tile in a chronological order.

17. The computer-implemented method of claim 10, wherein each tile is mapped onto a three-dimensional representation of a sphere that represents Earth.

18. (canceled)

19. (canceled)

20. (canceled)
